(19) United States
(12) Patent Application Publication
(10) Pub. No.: US 2025/0374081 A1
(43) Pub. Date: Dec. 4, 2025

(54) SCHEDULING FOR DEVICES PROVIDING MACHINE LEARNING PROCESSES AS A SERVICE

(71) Applicant: QUALCOMM Incorporated, San Diego, CA (US)

(72) Inventors: Hua WANG, Basking Ridge, NJ (US); Junyi LI, Greentown, PA (US); Tien Viet NGUYEN, Bridgewater, NJ (US)

(21) Appl. No.: 18/732,144

(22) Filed: Jun. 3, 2024

(51) Int. Cl. H04W 24/02; H04W 72/0446; H04W 72/1273; H04W 80/02

(52) U.S. Cl. CPC H04W 24/02; H04W 72/0446; H04W 72/1273; H04W 80/02

(57) ABSTRACT

Methods, systems, and devices for wireless communication are described. A first user equipment (UE) may receive a configuration signal that indicates a set of downlink slots and a set of configured grants for communicating on a set of uplink slots. In some cases, the downlink and uplink slots may be for communications from a set of UEs including the first UE, where the set of UEs perform a coordinated multi-layer machine learning process. The first UE may transmit an uplink signal in an uplink slot from the set of uplink slots indicating a result from performing a first subset of processes of the coordinated multi-layer machine learning process. The first UE may then receive a group physical downlink control channel signal indicating that an upcoming slot is allocated to a second UE for performing a second subset of processes of the coordinated multi-layer machine learning process.

### FIELD OF TECHNOLOGY

The following relates to method for wireless communication, including scheduling for devices providing machine learning processes as a service.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first user equipment (UE) is described. The method may include receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process, transmitting an uplink signal in an uplink slot from the set of multiple uplink slots in accordance with the configuration signal, where the uplink signal includes an indication of a result from performing a first subset of processes of the coordinated multi-layer machine learning process, and receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

A first UE for wireless communications is described. The first UE may include one or more memories storing processor executable code, and one or more processors coupled with the one or more memories. The one or more processors may individually or collectively be operable to execute the code to cause the first UE to receive a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process, transmit an uplink signal in an uplink slot from the set of multiple uplink slots in accordance with the configuration signal, where the uplink signal includes an indication of a result from performing a first subset of processes of the coordinated multi-layer machine learning process, and receive, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

Another first UE for wireless communications is described. The first UE may include means for receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process, means for transmitting an uplink signal in an uplink slot from the set of multiple uplink slots in accordance with the configuration signal, where the uplink signal includes an indication of a result from performing a first subset of processes of the coordinated multi-layer machine learning process, and means for receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

A non-transitory computer-readable medium storing code for wireless communications is described. The code may include instructions executable by one or more processors to receive a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process, transmit an uplink signal in an uplink slot from the set of multiple uplink slots in accordance with the configuration signal, where the uplink signal includes an indication of a result from performing a first subset of processes of the coordinated multi-layer machine learning process, and receive, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

Some examples of the method, UEs, and non-transitory computer-readable medium described herein may further include operations, features, means, or instructions for receiving, prior to transmitting the uplink signal, a downlink signal in a downlink slot from the set of multiple downlink slots in accordance with the configuration signal, the downlink signal including a prompt associated with the coordinated multi-layer machine learning process and performing the first subset of processes of the coordinated multi-layer machine learning process using the prompt to identify the result.

Some examples of the method, UEs, and non-transitory computer-readable medium described herein may further include operations, features, means, or instructions for receiving, after transmitting the uplink signal, a downlink signal in a downlink slot from the set of multiple downlink slots in accordance with the group physical downlink control channel, the downlink signal including a second result associated with the second subset of processes of the coordinated multi-layer machine learning process and performing the first subset of processes of the coordinated multi-layer machine learning process using the second result to identify a third result.

Some examples of the method, UEs, and non-transitory computer-readable medium described herein may further include operations, features, means, or instructions for transmitting a second uplink signal in a second uplink slot from the set of multiple uplink slots in accordance with the group physical downlink control channel, where the second uplink signal includes an indication of the third result.

In some examples of the method, UEs, and non-transitory computer-readable medium described herein, the third result includes a token in response to a prompt received from a user. In some examples of the method, UEs, and non-transitory computer-readable medium described herein, the coordinated multi-layer machine learning process includes a set of multiple sub-layers associated with a large language model deployed as a service by the set of multiple UEs.

In some examples of the method, UEs, and non-transitory computer-readable medium described herein, the first UE and the second UE in the set of multiple UEs may be associated with different modulation and coding schemes. In some examples of the method, UEs, and non-transitory computer-readable medium described herein, the set of multiple UEs may be deployed using a centralized server or in a distributed operation.

A method for wireless communications by a first UE is described. The method may include communicating an application layer message including a request for service indicating a request to participate in a coordinated multi-layer machine learning process, receiving a medium access control (MAC) layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes, and outputting a second MAC layer message including a second result based on performing a second subset of processes of the coordinated multi-layer machine learning process on the received result.

A first UE for wireless communications is described. The first UE may include one or more memories storing processor executable code, and one or more processors coupled with the one or more memories. The one or more processors may individually or collectively be operable to execute the code to cause the first UE to communicate an application layer message including a request for service indicating a request to participate in a coordinated multi-layer machine learning process, receive a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes, and output a second MAC layer message including a second result based on performing a second subset of processes of the coordinated multi-layer machine learning process on the received result.

Another first UE for wireless communications is described. The first UE may include means for communicating an application layer message including a request for service indicating a request to participate in a coordinated multi-layer machine learning process, means for receiving a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes, and means for outputting a second MAC layer message including a second result based on performing a second subset of processes of the coordinated multi-layer machine learning process on the received result.

A non-transitory computer-readable medium storing code for wireless communications is described. The code may include instructions executable by one or more processors to communicate an application layer message including a request for service indicating a request to participate in a coordinated multi-layer machine learning process, receive a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes, and output a second MAC layer message including a second result based on performing a second subset of processes of the coordinated multi-layer machine learning process on the received result.

Some examples of the method, UEs, and non-transitory computer-readable medium described herein may further include operations, features, means, or instructions for communicating a second application layer message between the first UE and the second UE, the second application layer message including an indication of a set of service layers associated with the coordinated multi-layer machine learning process hosted at the second UE.

In some examples of the method, UEs, and non-transitory computer-readable medium described herein, communicating the application layer message may include operations, features, means, or instructions for communicating the application layer message between the first UE and the second UE, the application layer message indicating at least one of the set of service layers associated with the coordinated multi-layer machine learning process based on the second application layer message.

Some examples of the method, UEs, and non-transitory computer-readable medium described herein may further include operations, features, means, or instructions for communicating an internet protocol layer message between the first UE and the second UE, the internet protocol layer message including an indication of a routing table associated with a service chain for the coordinated multi-layer machine learning process.

Some examples of the method, UEs, and non-transitory computer-readable medium described herein may further include operations, features, means, or instructions for receiving, from a third UE, a prompt for inputting into the coordinated multi-layer machine learning process, where the second result includes a token in response to the received prompt.

In some examples of the method, UEs, and non-transitory computer-readable medium described herein, the coordinated multi-layer machine learning process includes a set of multiple sub-layers associated with a large language model.

In some examples of the method, UEs, and non-transitory computer-readable medium described herein, the first UE and the second UE may be deployed using a centralized server or in a distributed operation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports scheduling for devices providing machine learning processes as a service in accordance with one or more aspects of the present disclosure.

FIG. 2 shows an example of a wireless communications system that supports scheduling for devices providing machine learning processes as a service in accordance with one or more aspects of the present disclosure.

FIG. 3 shows an example of signaling that supports scheduling for devices providing machine learning processes as a service in accordance with one or more aspects of the present disclosure.

FIG. 4 shows an example of signaling that supports scheduling for devices providing machine learning processes as a service in accordance with one or more aspects of the present disclosure.

FIG. 5 shows an example of a communication timeline that supports scheduling for devices providing machine learning processes as a service in accordance with one or more aspects of the present disclosure.

FIGS. 6 and 7 show block diagrams of devices that support scheduling for devices providing machine learning processes as a service in accordance with one or more aspects of the present disclosure.

FIG. 8 shows a block diagram of a communications manager that supports scheduling for devices providing machine learning processes as a service in accordance with one or more aspects of the present disclosure.

FIG. 9 shows a diagram of a system including a device that supports scheduling for devices providing machine learning processes as a service in accordance with one or more aspects of the present disclosure.

FIGS. 10 through 13 show flowcharts illustrating methods that support scheduling for devices providing machine learning processes as a service in accordance with one or more aspects of the present disclosure.

### DETAILED DESCRIPTION

Wireless communications systems may often support large language models. However, some large language models may use a large number of parameters and include many processing layers. Running large language models may result in an increased use of memory and computational power. Accordingly, one or more edge devices (e.g., UEs) may not have sufficient resources to load the entire large language model to its memory and run the inference. To support running of large language models, an edge device can provide large language model sub-layers as a service to users, both in centralized and in distributed manner. However, the system architecture and signaling aspects of wireless communications systems supporting large language model sub-layers deployed as a service may be underdeveloped.

One or more aspects of the present disclosure may provide for system architecture and signaling aspects of wireless communications systems supporting large language model sub-layers deployed as a service. In particular, multiple cooperative edge devices may run a large language model such that each edge device provides a partial large language model service by taking input and generating outputs using forward propagation of the input through sub-layers of the large language model. The edge device may receive an intermediate result and/or prompts using downlink slots and may transmit a result from a large language model processing using an uplink slot. In some aspects, an edge device may request downlink retransmission thereby impacting pre-scheduled upcoming downlink and uplink slot timings.

As one aspect, an edge device may receive a persistent scheduling for a set of downlink slots and configured grant for a set of uplink slots. The edge device may transmit an uplink signal in accordance with the configured uplink slots. The edge device may then receive a group physical downlink control channel indicating an edge device associated with an upcoming uplink or downlink slot.

In another aspect, the edge device may use an application layer messaging device to indicate a request for service. The edge device may then receive a medium access control (MAC) layer message indicating an intermediate result from running a subset of processes at another edge device. The MAC layer message may include a MAC header indicating indices of required service layers for the edge device. The edge device may then output a second MAC layer message indicating a second result based on performing a second subset of processes on the intermediate result.

Aspects of the disclosure are initially described in the context of wireless communications systems. Aspects of the disclosure are further illustrated by and described with reference to signaling and communication timeline. Aspects of the disclosure are further illustrated by and described with reference to apparatus diagrams, system diagrams, and flowcharts that relate to scheduling for devices providing machine learning processes as a service.

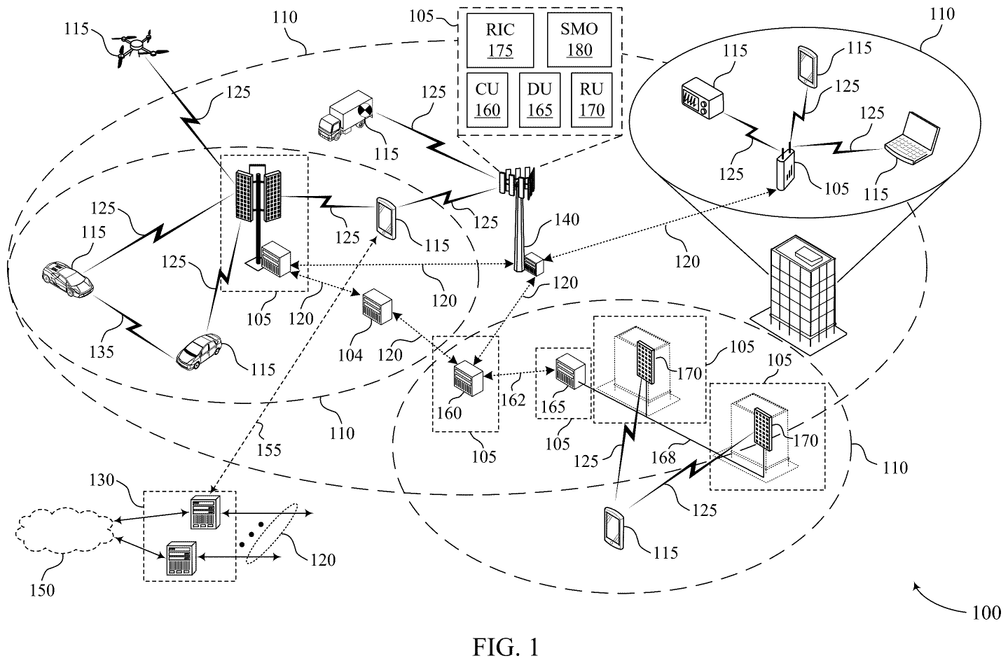

FIG. 1 shows an example of a wireless communications system 100 that supports scheduling for devices providing machine learning processes as a service in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Many wireless communications systems may implement machine learning processes to enhance or further refine its operations. A large language model is an example of such a machine learning process. However, with an increase in capability, such large language models may be very large and may include many layers. In some cases, a wireless communications system may operate in accordance with a decoder implemented large language model architecture. In such an architecture, an input prompt may be processed sequentially by N decoder blocks to identify a prompt embedding. The architecture may support generation of a new token based on the prompt embedding. The generated token may then be appended to the prompt to make a new prompt. Subsequently, the system may generate another token based on the new prompt.

As discussed herein, the applicability of large language models in wireless communications may increase. Some wireless communications systems may implement a transformer based foundation model to perform channel state information estimation, channel state information compression, and beam management, among others. In some examples, large language models and/or generative artificial intelligence may be used in digital twin application, to model wireless environment, monitor and optimize the operation of wireless systems. However, running large language models may involve increased use of memory and computational power. As one example, a large language model may have 135 billion parameters and may use at least 320 GB VRAM to run inference. Additionally or alternatively, another example of large language model may have 175 billion parameters and use at least 400 GB VRAM to run inference. However, processing capabilities in edge devices (e.g., UEs), often, may be limited. A capable edge device may have less than 10 GB VRAM, and may not be able to support a complete large language model deployment. For instance, an edge device such as a mobile phone may not have sufficient resource to load a complete large language model to its memory (e.g., graphics processing unit (GPU)) and run the inference.

In order to run inference on edge devices, in some examples, a wireless communications system may support a smaller size optimized model. For example, the wireless communications system may support a 7 billion model large language model on a smart phone device. However, a smaller size model may involve a trade off in terms of inference performance. In some cases, the edge device may be configured to load part (some layers) of the large language model to GPU, and run forward propagation to generate token or perform inference through the loaded layers. In some examples, the wireless communications system may then load the subsequent layers of the large language model to the GPU (e.g., swap memory) by taking the output of the previous loaded layers as input, and continuing the forward propagation process.

Additionally, or alternatively, the wireless communications system may support dividing the large language model into small parts, and deploying each part in different edge devices. In some examples, such edge devices may cooperatively perform forward progression with small amount of data exchange between those devices. According to one or more aspects depicted herein, an edge device may provide large language model sub-layers as a service to users, both in centralized and in distributed manner. In some aspects, the techniques depicted herein provide for a system architecture and signaling aspects for edge devices cooperatively providing large language model sub-layers as a service to users.

In some examples, a first UE may receive a configuration signal that indicates a set of downlink slots and a set of configured grants for communicating on a set of uplink slots. In some examples, the set of downlink slots and the set of uplink slots may be for communications from a set of UEs including the first UE, where the set of UEs perform a coordinated multi-layer machine learning process. In some cases, the first UE may transmit an uplink signal in an uplink slot from the set of uplink slots in accordance with the configuration signal, where the uplink signal includes an indication of a result from performing a first subset of processes of the coordinated multi-layer machine learning process. In some examples, the first UE may receive, after transmitting the uplink signal, a group physical downlink control channel signal indicating that an upcoming slot from the set of downlink slots or the set of uplink slots is allocated to a second UE from the set of UEs for performing a second subset of processes of the coordinated multi-layer machine learning process.

Additionally, or alternatively, one or more aspects of the present disclosure provide for a first UE communicating an application layer message including a request for service indicating a request to participate in a coordinated multi-layer machine learning process. In some examples, the first UE may receive a MAC layer message including a response indicating a result generated by a first subset of processes of the coordinated multi-layer machine learning process. In some cases, the coordinated multi-layer machine learning process may be provided as a service by a second UE. In some cases, the response may include a header portion indicating at least one index corresponding to one or more service layers for the first subset of processes. The first UE may then output a second MAC layer message including a second result based on performing a second subset of processes of the coordinated multi-layer machine learning process on the received result.

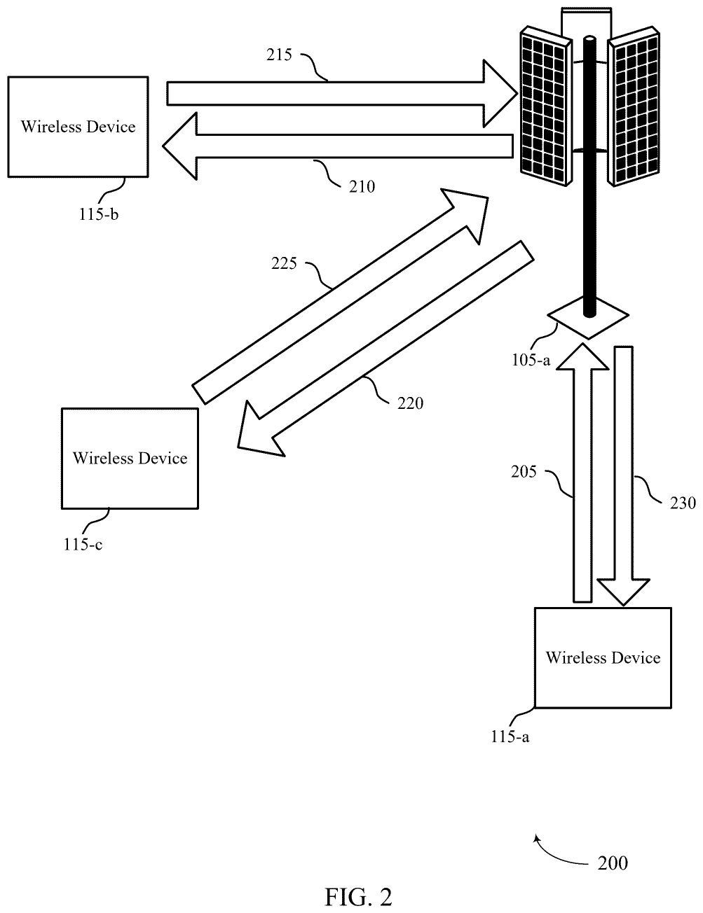

FIG. 2 shows an example of a wireless communications system 200 that supports scheduling for devices providing machine learning processes as a service in accordance with one or more aspects of the present disclosure. The wireless communications system 200 may implement or may be implemented by aspects of the wireless communications system 100. For example, the wireless communications system 200 may include a first wireless device 115-a (e.g., an edge device as a large language model user), a second wireless device 115-b (e.g., an edge device providing large language model as a service), third wireless device 115-c (e.g., an edge device providing large language model as a service), and a network entity 105-a (e.g., server), which may be examples of corresponding devices described with reference to FIG. 1.

As depicted in the example of FIG. 2, the wireless device 115-b and the wireless device 115-c may provide a cooperative machine learning model processes as a service. For instance, the wireless device 115-b may support a first subset of processes of the machine learning model and the wireless device 115-c may support a second subset of processes of the machine learning model. In some instances, the machine learning model may include a large language model. Running a large language model on several cooperative edge devices may have an advantage with respect to token-generation rate over running the large language model on one edge device with memory swapping of partial model. According to one or more aspects, an edge may provide a partial large language model service by taking inputs and generate output using forward propagation of the input through part of a large language model (e.g., using several decoder layers). In some examples, using large language model as a service may be through a centralized server, or through distributed (e.g., P2P) network.

At 205, the wireless device 115a may transmit a request for service from the large language model. The request for service may include a prompt for response from the large language model. As discussed herein, the large language model may be implemented, in sections, by the wireless device 115b and the wireless device 115c. In some examples, one or more edge devices may register to a server as a (partial) large language model service provider. For instance, the wireless device 115b may indicate that the wireless device 115b may support a first subset of processes of a coordinated multi-layer machine learning process (e.g., a first subset of layers associated with the large language model). In some examples, the wireless device 115c may indicate that the wireless device 115c may support a second subset of processes of a coordinated multi-layer machine learning process (e.g., a second subset of layers associated with the large language model). Additionally, or alternatively, the wireless device 115b and the wireless device 115c may indicate, to the network entity 105a (e.g., server), which layer(s) will be hosted at the corresponding wireless device. In some cases, the wireless devices may also indicate a capability to perform forward progression, and a corresponding metric (such as, the time it takes to perform forward progression through the hosted layers). In addition, the wireless devices providing large language model as a service can also include a price to use its service. In some examples, a server may advise to the network that it can provide large language model inference service. Additionally, or alternatively, the server can provide a web interface, or an application programming interface (API) to users (e.g., wireless device 115a).

A user (e.g., wireless device 115a) requesting to use the service (e.g., large language model as a service) may provide a request to the server (e.g., network entity 105a). In addition, the request can also include the user's desired token rate and the price the user is willing to pay for the service. Once the request is granted, the user (e.g., wireless device 115a) can start to send the prompt to the server.

Upon receiving the prompt from the wireless device 115a (e.g., user), the network entity 105a may identify a relevant chain of service provided by one or more edge devices. For example, the network entity 105a may identify that the wireless device 115b may perform a first subset of processes of a coordinated multi-layer machine learning process and that the wireless device 115c may perform a second subset of processes of the coordinated multi-layer machine learning process. Additionally, or alternatively, the server may receive the request, and identify that one or more edge devices may provide the service by performing a sequential forward processing through the layers hosted on a corresponding edge device. The edge devices may cooperatively perform forward processing to implement the entire large language model.

At 210, the network entity 105a may forward the prompt to the wireless device 115b. The wireless device 115b may perform the first subset of processes of the coordinated multi-layer machine learning process (e.g., large language model) upon receiving the prompt.

At 215, the wireless device 115b may transmit an intermediate result to the network entity. For instance, the network entity 105a may receive an intermediate result generated by a first part of a large language model. At 220, the network entity 105a may forward the intermediate result to the wireless device 115c (second edge device providing large language model as a service). The wireless device 115c may perform the second subset of processes of the coordinated multi-layer machine learning process (e.g., large language model) upon receiving the intermediate result. In some cases, the wireless device 115c may generate a token to be provided to the user (e.g., wireless device 115a).

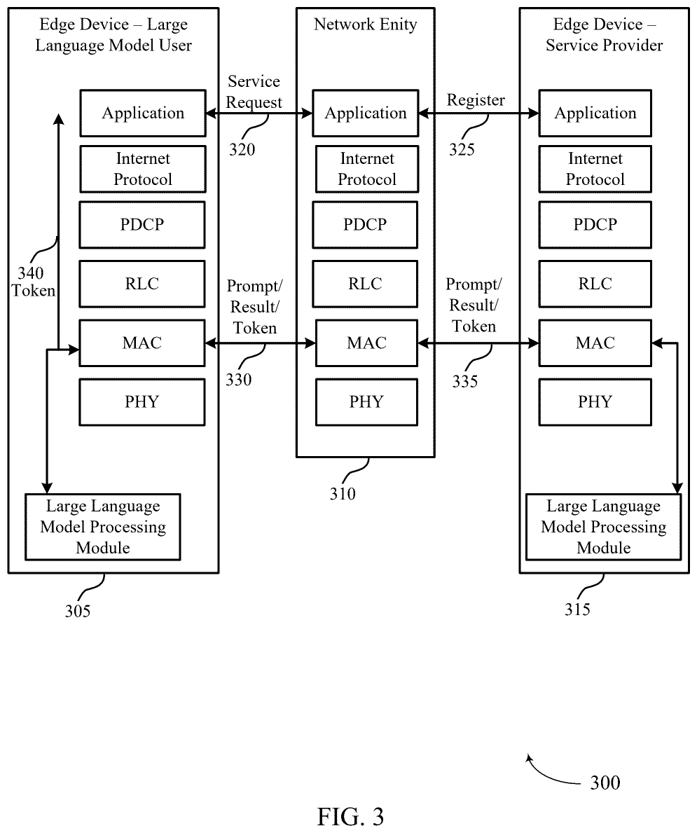

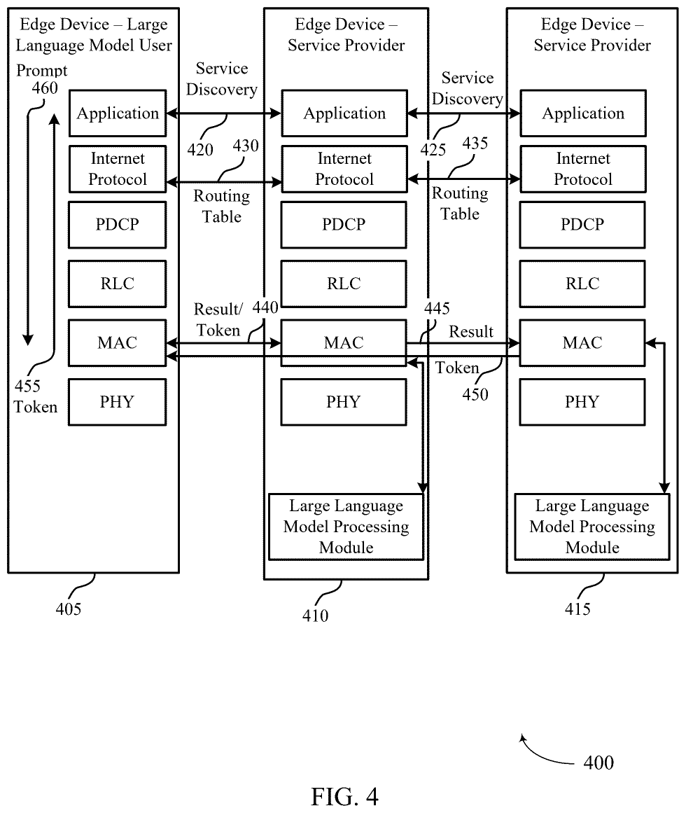

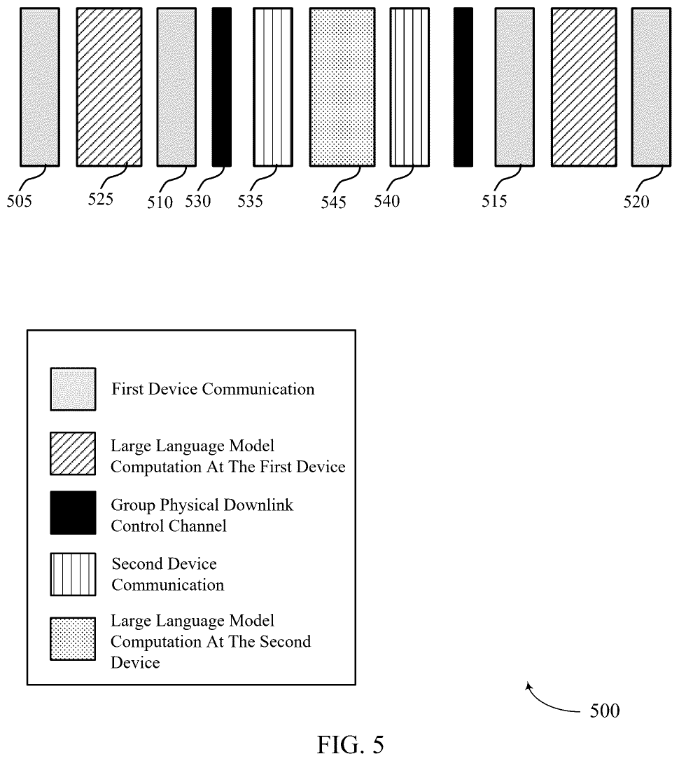

At 225, the wireless device 115c may transmit the generated token to the network entity 105a. At 230, the network entity 105a may provide the generated token to the wireless device 115a. In some cases, the network entity 105a may provide the generated token to the wireless device 115b or a third wireless device (not shown) for further processing (e.g., performing forward processing). Thus, the techniques depicted herein provide for implementing a machine learning processes as a service. FIGS. 3 and 4 further describe one or more signaling aspects of the techniques for implementing the machine learning processes as a service. FIG. 5 is directed to communication architecture for techniques for implementing the machine learning processes as a service.

FIG. 3 shows an example of signaling 300 that supports scheduling for devices providing machine learning processes as a service in accordance with one or more aspects of the present disclosure. The signaling 300 may be implemented by an edge device 305 (e.g., a wireless device supporting a user of a large language model), a network entity 310, and an edge device 315 (e.g., a wireless device providing large language model as a service). In some examples, the network entity 310 may include a server. Alternatively, the server may include a standalone cloud server connected to the network entity 310. In the example of FIG. 3, the edge devices may communicate with the server through the network entity 310.

Each edge device (e.g., edge device 305 and edge device 315) and the network entity 310 may communicate using one or more communication layers. Each device may support an application (App) layer, an Internet Protocol (IP) layer, a PDCP layer, an RLC layer, a MAC layer and a PHY layer. For wireless communications between the service provider (edge device) and the network entity 310, the registration and transmission of forward processing results may occur at different communication layers. Registration of edge devices (where edge devices indicate serviceability and is registered with the network entity 310) may happen at an application layer (e.g., because it may happen infrequently and may not be time critical). In some examples, the edge device 315 may communicate an application layer message 325 indicating a request to participate in a coordinated multi-layer machine learning process. In some examples, the edge device 315 may communicate the application layer message 325 including an indication of a set of service layers associated with the coordinated multi-layer machine learning process hosted at the edge device 315. In some examples, the edge device 305 may transmit a request for service at the application layer. For example, the edge device 305 may communicate an application layer message 320 including a service request.

In some examples, the edge device 315 may receive the request for service from the network entity 310. The edge device 315 may perform a first subset of processes of a coordinated multi-layer machine learning process (e.g., large language model) to identify an intermediate result (e.g., forward processing result). Although not depicted herein, the network entity 105a may forward the intermediate result to a second edge device providing large language model as a service.

The pass of the intermediate result (e.g., forward processing result) may occur at the MAC layer without passing through the whole data plane. In some examples, there may be a direct data path between the MAC layers of corresponding devices and a forward processing computation module. The direct data path may reduce the latency of the data transmission within the edge device. In some examples, the edge device 315 may receive a MAC layer message 335 including a prompt received from the network entity 310. For example, the edge device 315 may receive a prompt for inputting into the coordinated multi-layer machine learning process, where a second result includes a token in response to the received prompt.

In some examples, the edge device 315 may receive a MAC layer message including a response indicating a result generated by a first subset of processes of the coordinated multi-layer machine learning process. In this case, the first subset of processes of the coordinated multi-layer machine learning process may be performed by a second edge device. In some examples, the coordinated multi-layer machine learning process may be provided as a service by the second edge device. In some examples, the response may include a header portion indicating at least one index corresponding to one or more service layers for the first subset of processes. For example, the MAC header may be associated with the large language model layer service. In some examples, the MAC header may include the indices of one or more service layers for the edge device. In some examples, the network entity 310 may utilize the MAC header to determine which large language model layers are to participate in the forward processing computation.

In some examples, the edge device 315 may perform the first subset of processes to determine a first result. The edge device may output a second MAC layer message including a second result based on performing a second subset of processes of the coordinated multi-layer machine learning process on the received result. The generated token 340 may then be passed to the application layer of the requesting device. In some examples, the network entity 310 may receive the result from the edge device 315 and the network entity 310 may forward the result via a MAC message 330 to the requesting edge device 305.

As depicted herein, the service request may be associated with performing a first subset of large language model layers to identify a forward processing computation. In some examples, the intermediate results may then be forwarded to the server.

FIG. 4 shows an example of signaling 400 that supports scheduling for devices providing machine learning processes as a service in accordance with one or more aspects of the present disclosure. The signaling 400 may be implemented by an edge device 405 (e.g., a wireless device supporting a user of a large language model), an edge device 410 (e.g., a first wireless device providing large language model as a service), and an edge device 415 (e.g., a second wireless device providing large language model as a service). The signaling 400 may provide for the use of machine learning processes as a service in a P2P scenario.

Each edge device (e.g., edge device 405, edge device 410 and edge device 415) may communicate using one or more communication layers. Each device may support an application layer, an Internet Protocol layer, a PDCP layer, an RLC layer, a MAC layer and a PHY layer. In some examples, edge devices may advertise to the network that they are capable of providing a (partial) large language model service. For instance, the edge device 410 and the edge device 415 may provide a coordinated multi-layer machine learning process as a service, where the edge device 410 performs a first subset of processes and the edge device 415 performs a second subset of processes.

In some examples, the broadcast information (e.g., via an application layer message 425 for service discovery) may include an indication of the layer(s) hosted by the corresponding edge device to perform forward processing. Additionally, the broadcast information may indicate a corresponding metric such as the time it takes for the edge device to perform forward processing through those layers, the communication rate of the edge device, etc. In some cases, in the broadcast information, an edge device may also include a price to use its service.

In some examples, a user (e.g., edge device 405) may discover the advertised services via an application layer message 420. In some examples, the user may also identify a service provider and find a chain of service provided by edge devices. The user may determine the chain of service such that by performing sequential forward processing through the layers hosted on those devices, a forward processing through the whole large language model may be completed. In selecting the providers in the chain, the user may take into account of the performance metric advertised by the service provider. In some examples, the edge device 410 and the edge device 405 may communicate an application layer message 420 associated with a service discovery signal. In some examples, a service provider may use the service discovery signal to advertise its service for the user to discover, or the user may send a service request signal and the service provider may provide a response using the service discovery signal.

In some examples, the user may establish a chain of service by sending a routing table which may include the whole chain information to the first service provider. In some examples, a device in the chain may forward the routing table to the next service provider the routing table that includes the downstream devices in the chain. In some cases, the edge device 405 may communicate an internet protocol layer message 430 including an indication of a routing table associated with a service chain for the coordinated multi-layer machine learning process. Additionally, the edge device 410 may communicate the internet protocol layer message 435 including an indication of the routing table associated with a service chain for the coordinated multi-layer machine learning process. The routing table signal, as depicted herein, may be communicated in the internet protocol layer. A pre-established service chain may reduce the latency in finding a following service provider. When implementing the service chain without considering latency, the devices may communicate the routing table using MAC layer messaging along with the prompt or token or forward processing results.

As depicted in the example of FIG. 4, the user may send a prompt 460 to the first device in the chain (e.g., edge device 410). The edge device 410 may receive the and perform a forward processing. For example, the edge device 410 may perform a first subset of processes of the coordinated multi-layer machine learning process based on receiving the prompt. The edge device 410 may then send the result (via MAC layer message 445) to the next device in the routing table (e.g., edge device 415). In some examples, the edge device 410 may send the result to the edge device 405 via MAC layer message 440. In some examples, the edge device 415 may receive the result (e.g., intermediate result) from the edge device 410 and perform a second subset of the coordinated multi-layer machine learning process to identify a result (or token). The edge device 410 may generate a token 455 and communicate the token to the edge device 405 via MAC layer message 450. As discussed herein, the last device in the chain of service may generate a token, and send back the token to both the user and the first device in the chain (for auto-regressively generating next token). In some examples, the edge devices may communicate the intermediate forward processing result at the MAC layer without passing through the whole data plane. There may be a direct data path between the MAC layer and a forward processing computation module to reduce the latency of the data transmission within the edge device.

In some examples, the edge device 415 may receive a MAC layer message 445 including a response indicating a result generated by a first subset of processes of the coordinated multi-layer machine learning process. In such cases, the coordinated multi-layer machine learning process may be provided as a service by the edge device 410. In some examples, the response may include a header portion indicating at least one index corresponding to one or more service layers for the first subset of processes. In some examples, the MAC header may be associated with the large language model layer service. The MAC header can include the indices of the service layers for the edge device to decide which large language model layers may be used in the forward processing computation.

One or more aspects of the present disclosure provide for a distributed system including edge devices supporting users of the coordinated multi-layer machine learning process and edge devices providing the coordinated multi-layer machine learning process as a service. In the distributed case, the edge device can communicate via a network entity (as described with reference to FIG. 3), or they can directly communicate with each other (e.g., through sidelink). The techniques depicted herein may provide for data (service) parallelism. In some cases, large language models may generate token auto-regressively. In such cases, an edge device may not start to work on the next token before the current one get generated and sent as a feedback to the first device in the chain. An edge device can provide (partial) large language model service to several users. In such cases, while a device finishes its forward processing computation for generating the current token and waiting to start forward processing computation for the next token for one users, it can run forward processing computation for another user.

Techniques depicted herein may provide for real-time load balancing. In some cases, a service provider (edge device) can provide its real-time load to the server (e.g., in centralized case), and the server may choose an appropriate chain of service providers. Additionally, or alternatively, a service provider may broadcast the services to the network (e.g., in distributed case), and a user may choose an appropriate chain of service providers.

Additionally or alternatively, the aspects depicted in the present disclosure may provide for adaptive layers. For example, a service provider (edge device) may declare its service is from layer n to layer m, and the server or the user may use part of the layers n to m from this provider for forward processing. This way, it may be more flexible for the server or the user to find a chain of service provider to perform to complete forward processing through large language models.

FIG. 5 shows an example of a communication timeline 500 that supports scheduling for devices providing machine learning processes as a service in accordance with one or more aspects of the present disclosure. The communication timeline may be performed by a first UE (e.g., edge device) providing a service related to a coordinated multi-layer machine learning process (e.g., large language model) and a second UE (e.g., edge device) requesting service (as a user) from the first edge device, which may be examples of corresponding devices described with reference to FIG. 1. Additionally, the communication timeline may include communications from a network entity 105, which may be an example of a corresponding device described with reference to FIG. 1.

In some cases, a downlink slot may include at least a control signal and a data signal. In some examples, a time difference between the control and data signals may be represented by K0, K1 and K2. The values for K0, K1, and K2 may depend on UE capability and frame configuration. For FR2, with 120 kHz tone spacing, K0, K1, and K2 may be 4 slots (0.6 ms). For FR1, with 15 kHz tone spacing, K0, K1, and K2 may be 2 slots (2 ms). In some cases, the time difference between uplink and downlink may depend on a network entity's processing of an uplink message (e.g., 0.5 ms).

In some examples, the UEs may operate in accordance with a targeted token rate. In some cases, the targeted token rate may be 20 token/seconds. For each edge device (e.g., UE), for each token, the time budget may be 25 ms. For FR2, downlink to computation may take 1.2 ms, and computation to uplink may take greater than 0.6 ms. To account for the time budget, in this example, an uplink scheduling request time may be ignored.

In some example, for FR1, downlink to computation may take 4 ms, and computation to uplink may take 2 ms. To account for the time budget, in this example, an uplink scheduling request time may be ignored. In FR2, communications may occupy less than 10% of the time budget, but in FR1, communications may occupy ¼ of the time budget.

According to one or more aspects of the present disclosure, the first UE and the second UE may operate according to a scheduling scheme to reduce the overhead of communication in distributed large language model inference. As depicted in the example of FIG. 5, the slots 505, 510, 515 and 520 may include communication slots for the first UE. The first UE may perform the computation (perform a first subset of processes for the coordinated multi-layer machine learning process) during a computation slot 525. The time between downlink to computation may depend on downlink processing time, which may be less than K1. Additionally, or alternatively, the time between computation to uplink may depend on an uplink processing time, which may be less than K2. In this example, there may not be a need for uplink scheduling request.

Wireless devices may be able to schedule retransmission in an example where all the time slots are flexible. However, when a UE is preconfigured with the uplink and downlink slots, if the time budget allows for retransmission, the UE may dynamically schedule the retransmission, and that the time slot for computation may not need to shift. Alternatively, if the time budget does not allow for retransmission, or with dynamically scheduled retransmission, the communication may not be successful and the UE may further need to shift the time slot of the computation. To align on the time slots used for computation and communication, the UEs may operate in accordance with a set of pre-scheduled slots.

In some examples, a network entity may use persistent scheduling for downlink and configured grant for uplink. In some examples, a first edge device may receive a configuration signal that indicates a set of downlink slots and a set of configured grants for communicating on a set of uplink slots. In some examples. the set of downlink slots and the set of uplink slots may be for communications from a set of UEs including the first UE, where the set of UEs may perform a coordinated multi-layer machine learning process. Each edge device may identify the pre-scheduled downlink and uplink slots for all the edge devices providing the same service. In some examples, each edge device can access all slots and each device may have different modulation and coding scheme table.

As depicted in the example of FIG. 5, the first UE may receive an indication of a downlink slot 505 and an uplink slot 510, via control signaling. The first UE may further receive an indication of the slot 525 dedicated to large language model computation at the first UE. In some cases, the first UE may receive a downlink signal in the downlink slot 505 in accordance with the configuration signal. In some cases, the downlink signal may include a prompt associated with the coordinated multi-layer machine learning process. During slot 525, the first UE may perform the first subset of processes of the coordinated multi-layer machine learning process using the prompt to identify a result. The first UE may transmit an uplink signal in an uplink slot 510 in accordance with the configuration signal. In some cases, the uplink signal may include an indication of a result from performing a first subset of processes of the coordinated multi-layer machine learning process.

After transmitting the uplink signal, the group of UEs may receive a group physical downlink control channel signal 530 indicating that an upcoming slot (e.g., downlink slot 535) is allocated to a second UE for performing a second subset of processes of the coordinated multi-layer machine learning process. This way, the group of UEs may be aligned on the resources, in case the originally allocated slots were shifted during a retransmission.

In the example depicted in FIG. 5, the second UE may receive the group physical downlink control channel signal 530 and may determine that the following slots (e.g., downlink slot 535 and uplink slot 540) are allocated to the second UE. In such cases, the second UE may receive a downlink signal (e.g., including the intermediate result from the first UE) in the downlink slot 540 in accordance with the configuration signal and the group physical downlink control channel signal 530. During slot 545, the second UE may perform the second subset of processes of the coordinated multi-layer machine learning process using the intermediate result from the first UE to identify a second result. The second UE may transmit an uplink signal in an uplink slot 540 in accordance with the configuration signal. In some cases, the uplink signal may include an indication of the second result from performing a second subset of processes of the coordinated multi-layer machine learning process.

According to the one or more aspects depicted herein, a group physical downlink control channel signal in between the uplink and downlink may indicate the edge device allocated to the next downlink and uplink slot. In some examples, the group physical downlink control channel signal may not schedule the downlink (which is already pre-scheduled). Thus, the time between the group physical downlink control channel signal and the downlink can be small (the physical downlink control channel processing time). In some cases, the techniques depicted herein may reduce the scheduling overhead and enable the distributed inference of large language model to fit in a tight time budget. However, if there is communication error and there is not enough time for retransmission within the current device's time window, then the group physical downlink control channel signal depicted herein may allow for a shift in the time window for each device and potentially lower the token rate. In some examples, the communication timeline using the group physical downlink control channel signal may be implemented for reliable communication link, or in a case where a communication for large language model inference is treated as URLLC traffic.

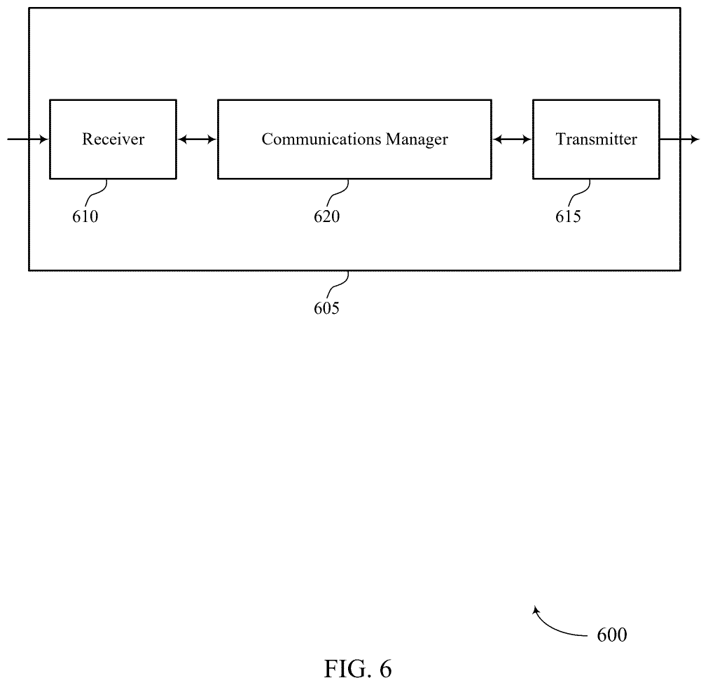

FIG. 6 shows a block diagram 600 of a device 605 that supports scheduling for devices providing machine learning processes as a service in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to scheduling for devices providing machine learning processes as a service). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scheduling for devices providing machine learning processes as a service). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of scheduling for devices providing machine learning processes as a service as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process. The communications manager 620 is capable of, configured to, or operable to support a means for transmitting an uplink signal in an uplink slot from the set of multiple uplink slots in accordance with the configuration signal, where the uplink signal includes an indication of a result from performing a first subset of processes of the coordinated multi-layer machine learning process. The communications manager 620 is capable of, configured to, or operable to support a means for receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

Additionally, or alternatively, the communications manager 620 may support wireless communications in accordance with examples as disclosed herein. For example, the communications manager 620 is capable of, configured to, or operable to support a means for communicating an application layer message including a request for service indicating a request to participate in a coordinated multi-layer machine learning process. The communications manager 620 is capable of, configured to, or operable to support a means for receiving a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes. The communications manager 620 is capable of, configured to, or operable to support a means for outputting a second MAC layer message including a second result based on performing a second subset of processes of the coordinated multi-layer machine learning process on the received result.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

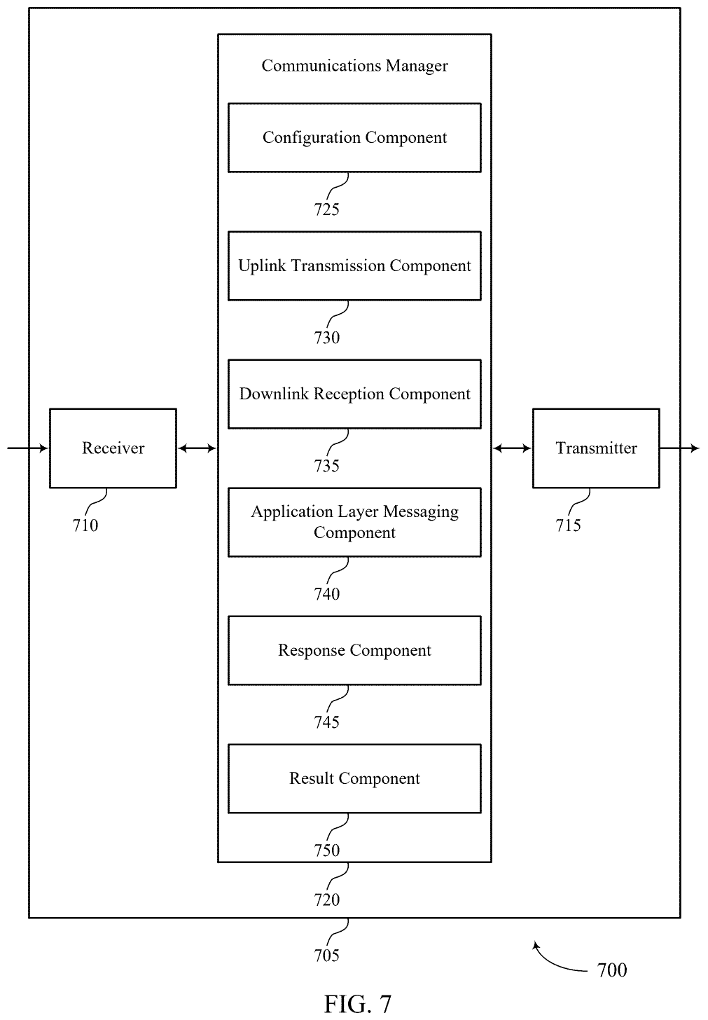

FIG. 7 shows a block diagram 700 of a device 705 that supports scheduling for devices providing machine learning processes as a service in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to scheduling for devices providing machine learning processes as a service). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to scheduling for devices providing machine learning processes as a service). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of scheduling for devices providing machine learning processes as a service as described herein. For example, the communications manager 720 may include a configuration component 725, an uplink transmission component 730, a downlink reception component 735, an application layer messaging component 740, a response component 745, a result component 750, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process. The uplink transmission component 730 is capable of, configured to, or operable to support a means for transmitting an uplink signal in an uplink slot from the set of multiple uplink slots in accordance with the configuration signal, where the uplink signal includes an indication of a result from performing a first subset of processes of the coordinated multi-layer machine learning process. The downlink reception component 735 is capable of, configured to, or operable to support a means for receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

Additionally, or alternatively, the communications manager 720 may support wireless communications in accordance with examples as disclosed herein. The application layer messaging component 740 is capable of, configured to, or operable to support a means for communicating an application layer message including a request for service indicating a request to participate in a coordinated multi-layer machine learning process. The response component 745 is capable of, configured to, or operable to support a means for receiving a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes. The result component 750 is capable of, configured to, or operable to support a means for outputting a second MAC layer message including a second result based on performing a second subset of processes of the coordinated multi-layer machine learning process on the received result.

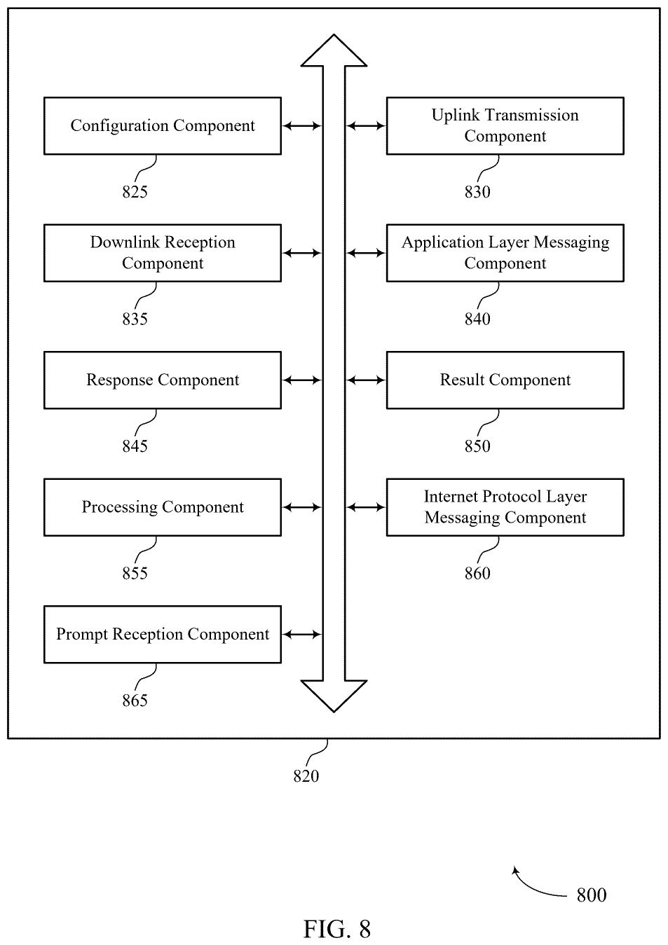

FIG. 8 shows a block diagram 800 of a communications manager 820 that supports scheduling for devices providing machine learning processes as a service in accordance with one or more aspects of the present disclosure. The communications manager 820 may be an example of aspects of a communications manager 620, a communications manager 720, or both, as described herein. The communications manager 820, or various components thereof, may be an example of means for performing various aspects of scheduling for devices providing machine learning processes as a service as described herein. For example, the communications manager 820 may include a configuration component 825, an uplink transmission component 830, a downlink reception component 835, an application layer messaging component 840, a response component 845, a result component 850, a processing component 855, an internet protocol layer messaging component 860, a prompt reception component 865, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process. The uplink transmission component 830 is capable of, configured to, or operable to support a means for transmitting an uplink signal in an uplink slot from the set of multiple uplink slots in accordance with the configuration signal, where the uplink signal includes an indication of a result from performing a first subset of processes of the coordinated multi-layer machine learning process. The downlink reception component 835 is capable of, configured to, or operable to support a means for receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

In some examples, the downlink reception component 835 is capable of, configured to, or operable to support a means for receiving, prior to transmitting the uplink signal, a downlink signal in a downlink slot from the set of multiple downlink slots in accordance with the configuration signal, the downlink signal including a prompt associated with the coordinated multi-layer machine learning process. In some examples, the processing component 855 is capable of, configured to, or operable to support a means for performing the first subset of processes of the coordinated multi-layer machine learning process using the prompt to identify the result.

In some examples, the downlink reception component 835 is capable of, configured to, or operable to support a means for receiving, after transmitting the uplink signal, a downlink signal in a downlink slot from the set of multiple downlink slots in accordance with the group physical downlink control channel, the downlink signal including a second result associated with the second subset of processes of the coordinated multi-layer machine learning process. In some examples, the processing component 855 is capable of, configured to, or operable to support a means for performing the first subset of processes of the coordinated multi-layer machine learning process using the second result to identify a third result.

In some examples, the uplink transmission component 830 is capable of, configured to, or operable to support a means for transmitting a second uplink signal in a second uplink slot from the set of multiple uplink slots in accordance with the group physical downlink control channel, where the second uplink signal includes an indication of the third result.

In some examples, the third result includes a token in response to a prompt received from a user. In some examples, the coordinated multi-layer machine learning process includes a set of multiple sub-layers associated with a large language model deployed as a service by the set of multiple UEs.

In some examples, the first UE and the second UE in the set of multiple UEs are associated with different modulation and coding schemes. In some examples, the set of multiple UEs are deployed using a centralized server or in a distributed operation.

Additionally, or alternatively, the communications manager 820 may support wireless communications in accordance with examples as disclosed herein. The application layer messaging component 840 is capable of, configured to, or operable to support a means for communicating an application layer message including a request for service indicating a request to participate in a coordinated multi-layer machine learning process. The response component 845 is capable of, configured to, or operable to support a means for receiving a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes. The result component 850 is capable of, configured to, or operable to support a means for outputting a second MAC layer message including a second result based on performing a second subset of processes of the coordinated multi-layer machine learning process on the received result.

In some examples, the application layer messaging component 840 is capable of, configured to, or operable to support a means for communicating a second application layer message between the first UE and the second UE, the second application layer message including an indication of a set of service layers associated with the coordinated multi-layer machine learning process hosted at the second UE.

In some examples, to support communicating the application layer message, the application layer messaging component 840 is capable of, configured to, or operable to support a means for communicating the application layer message between the first UE and the second UE, the application layer message indicating at least one of the set of service layers associated with the coordinated multi-layer machine learning process based on the second application layer message.

In some examples, the internet protocol layer messaging component 860 is capable of, configured to, or operable to support a means for communicating an internet protocol layer message between the first UE and the second UE, the internet protocol layer message including an indication of a routing table associated with a service chain for the coordinated multi-layer machine learning process.

In some examples, the prompt reception component 865 is capable of, configured to, or operable to support a means for receiving, from a third UE, a prompt for inputting into the coordinated multi-layer machine learning process, where the second result includes a token in response to the received prompt.

In some examples, the coordinated multi-layer machine learning process includes a set of multiple sub-layers associated with a large language model. In some examples, the first UE and the second UE are deployed using a centralized server or in a distributed operation.

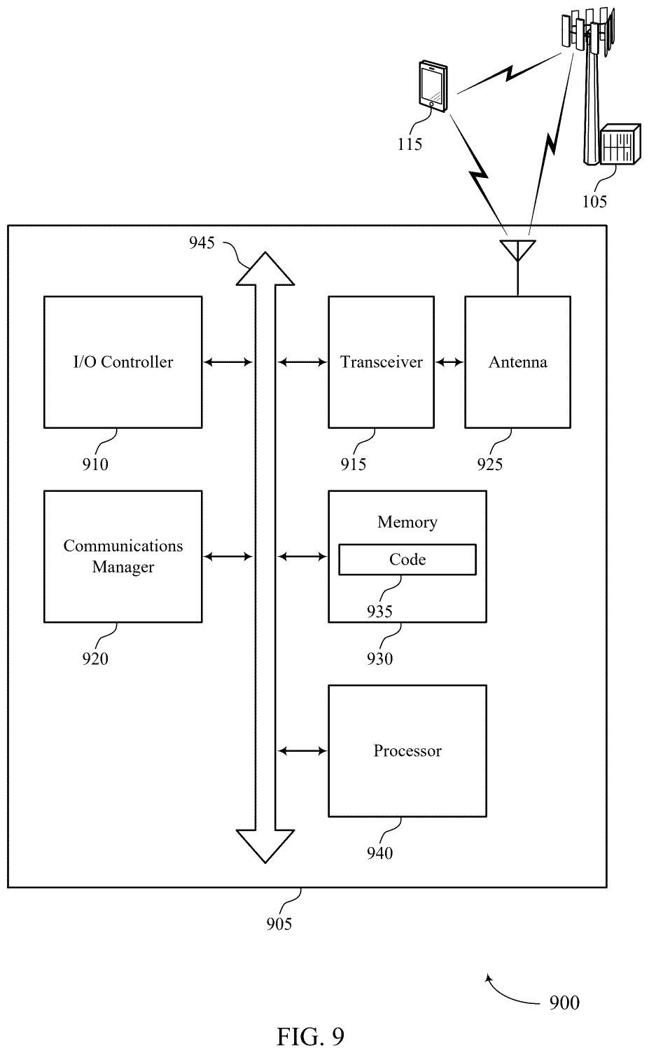

FIG. 9 shows a diagram of a system 900 including a device 905 that supports scheduling for devices providing machine learning processes as a service in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting scheduling for devices providing machine learning processes as a service). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process. The communications manager 920 is capable of, configured to, or operable to support a means for transmitting an uplink signal in an uplink slot from the set of multiple uplink slots in accordance with the configuration signal, where the uplink signal includes an indication of a result from performing a first subset of processes of the coordinated multi-layer machine learning process. The communications manager 920 is capable of, configured to, or operable to support a means for receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process.

Additionally, or alternatively, the communications manager 920 may support wireless communications in accordance with examples as disclosed herein. For example, the communications manager 920 is capable of, configured to, or operable to support a means for communicating an application layer message including a request for service indicating a request to participate in a coordinated multi-layer machine learning process. The communications manager 920 is capable of, configured to, or operable to support a means for receiving a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes. The communications manager 920 is capable of, configured to, or operable to support a means for outputting a second MAC layer message including a second result based on performing a second subset of processes of the coordinated multi-layer machine learning process on the received result.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of scheduling for devices providing machine learning processes as a service as described herein, or the at least one processor 940 and the at least one memory 930 may be otherwise configured to, individually or collectively, perform or support such operations.

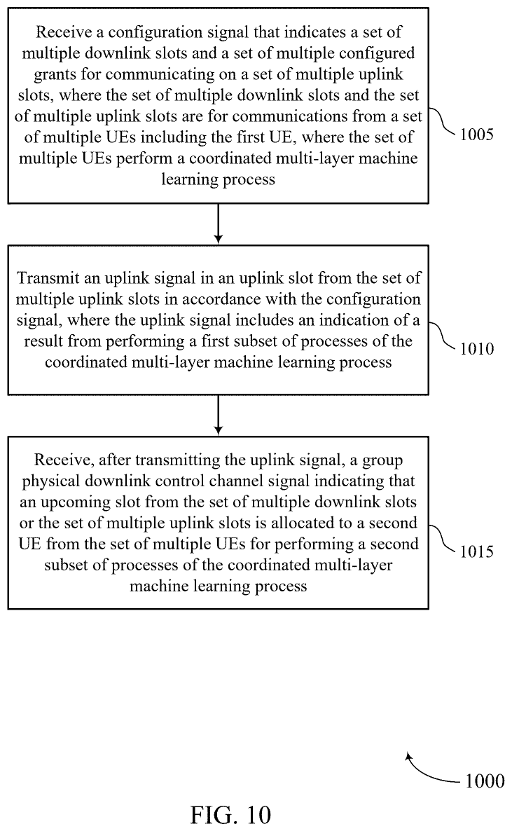

FIG. 10 shows a flowchart illustrating a method 1000 that supports scheduling for devices providing machine learning processes as a service in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a configuration signal that indicates a set of multiple downlink slots and a set of multiple configured grants for communicating on a set of multiple uplink slots, where the set of multiple downlink slots and the set of multiple uplink slots are for communications from a set of multiple UEs including the first UE, where the set of multiple UEs perform a coordinated multi-layer machine learning process. The operations of 1005 may be performed in accordance with examples as disclosed herein. In some examples, aspects of the operations of 1005 may be performed by a configuration component 825 as described with reference to FIG. 8.

At 1010, the method may include transmitting an uplink signal in an uplink slot from the set of multiple uplink slots in accordance with the configuration signal, where the uplink signal includes an indication of a result from performing a first subset of processes of the coordinated multi-layer machine learning process. The operations of 1010 may be performed in accordance with examples as disclosed herein. In some examples, aspects of the operations of 1010 may be performed by an uplink transmission component 830 as described with reference to FIG. 8.

At 1015, the method may include receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process. The operations of 1015 may be performed in accordance with examples as disclosed herein. In some examples, aspects of the operations of 1015 may be performed by a downlink reception component 835 as described with reference to FIG. 8.

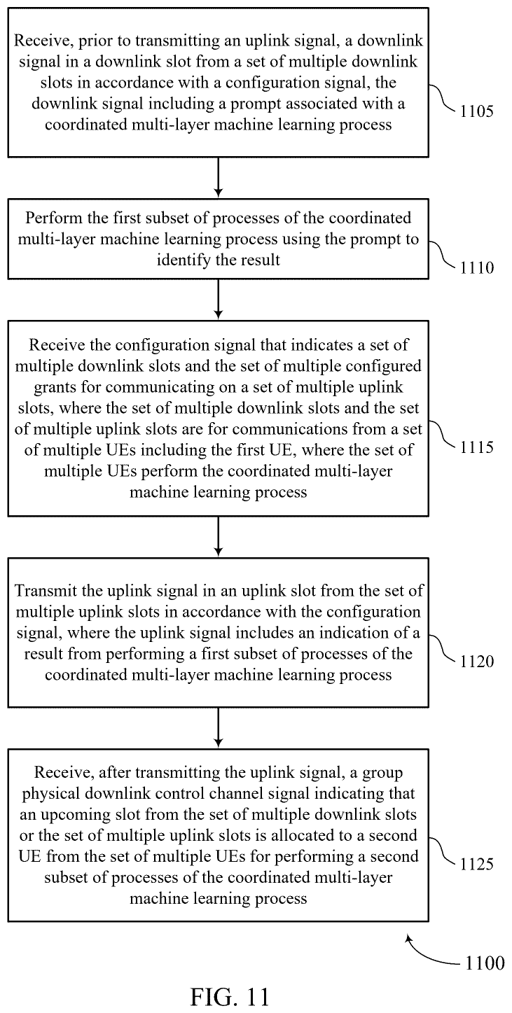

FIG. 11 shows a flowchart illustrating a method 1100 that supports scheduling for devices providing machine learning processes as a service in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving, prior to transmitting an uplink signal, a downlink signal in a downlink slot from a set of multiple downlink slots in accordance with a configuration signal, the downlink signal including a prompt associated with a coordinated multi-layer machine learning process. The operations of 1105 may be performed in accordance with examples as disclosed herein. In some examples, aspects of the operations of 1105 may be performed by a downlink reception component 835 as described with reference to FIG. 8.

At 1110, the method may include performing the first subset of processes of the coordinated multi-layer machine learning process using the prompt to identify the result. The operations of 1110 may be performed in accordance with examples as disclosed herein. In some examples, aspects of the operations of 1110 may be performed by a processing component 855 as described with reference to FIG. 8.

At 1115, the method may include receiving the configuration signal that indicates a set of multiple downlink slots and the set of multiple configured grants for communicating on a set of multiple uplink slots, where the set of multiple downlink slots and the set of multiple uplink slots are for communications from a set of multiple UEs including the first UE, where the set of multiple UEs perform the coordinated multi-layer machine learning process. The operations of 1115 may be performed in accordance with examples as disclosed herein. In some examples, aspects of the operations of 1115 may be performed by a configuration component 825 as described with reference to FIG. 8.

At 1120, the method may include transmitting the uplink signal in an uplink slot from the set of multiple uplink slots in accordance with the configuration signal, where the uplink signal includes an indication of a result from performing a first subset of processes of the coordinated multi-layer machine learning process. The operations of 1120 may be performed in accordance with examples as disclosed herein. In some examples, aspects of the operations of 1120 may be performed by an uplink transmission component 830 as described with reference to FIG. 8.

At 1125, the method may include receiving, after transmitting the uplink signal, a group physical downlink control channel signal indicating that an upcoming slot from the set of multiple downlink slots or the set of multiple uplink slots is allocated to a second UE from the set of multiple UEs for performing a second subset of processes of the coordinated multi-layer machine learning process. The operations of 1125 may be performed in accordance with examples as disclosed herein. In some examples, aspects of the operations of 1125 may be performed by a downlink reception component 835 as described with reference to FIG. 8.

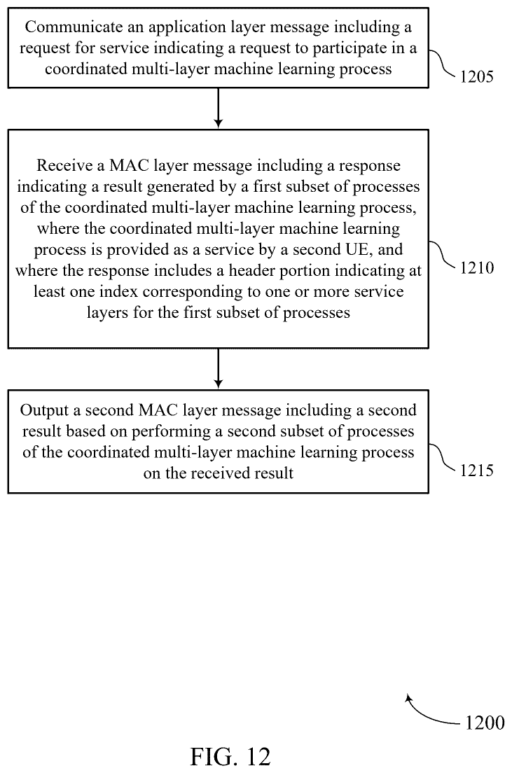

FIG. 12 shows a flowchart illustrating a method 1200 that supports scheduling for devices providing machine learning processes as a service in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include communicating an application layer message including a request for service indicating a request to participate in a coordinated multi-layer machine learning process. The operations of 1205 may be performed in accordance with examples as disclosed herein. In some examples, aspects of the operations of 1205 may be performed by an application layer messaging component 840 as described with reference to FIG. 8.

At 1210, the method may include receiving a MAC layer message including a response indicating a result generated by a first subset of processes of the coordinated multi-layer machine learning process, where the coordinated multi-layer machine learning process is provided as a service by a second UE, and where the response includes a header portion indicating at least one index corresponding to one or more service layers for the first subset of processes. The operations of 1210 may be performed in accordance with examples as disclosed herein. In some examples, aspects of the operations of 1210 may be performed by a response component 845 as described with reference to FIG. 8.

At 1215, the method may include outputting a second MAC layer message including a second result based on performing a second subset of processes of the coordinated multi-layer machine learning process on the received result. The operations of 1215 may be performed in accordance with examples as disclosed herein. In some examples, aspects of the operations of 1215 may be performed by a result component 850 as described with reference to FIG. 8.

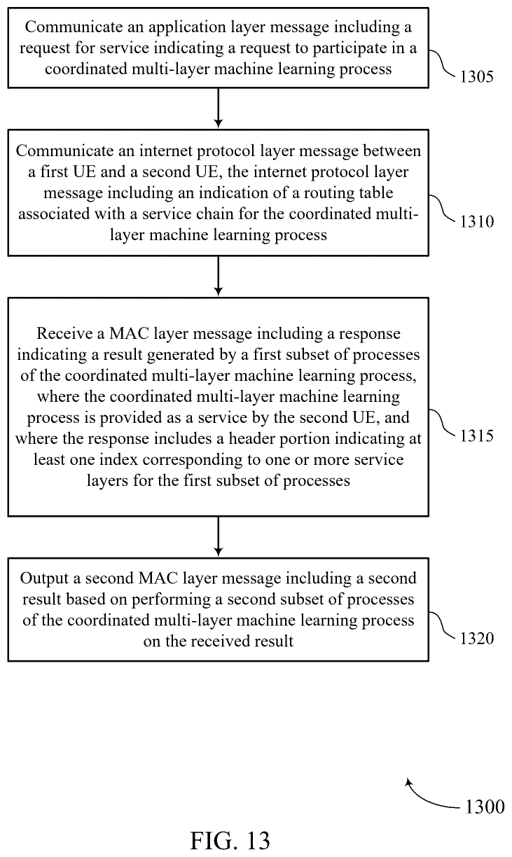

FIG. 13 shows a flowchart illustrating a method 1300 that supports scheduling for devices providing machine learning processes as a service in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include communicating an application layer message including a request for service indicating a request to participate in a coordinated multi-layer machine learning process. The operations of 1305 may be performed in accordance with examples as disclosed herein. In some examples, aspects of the operations of 1305 may be performed by an application layer messaging component 840 as described with reference to FIG. 8.

At 1310, the method may include communicating an internet protocol layer message between a first UE and a second UE, the internet protocol layer message including an indication of a routing table associated with a service chain for the coordinated multi-layer machine learning process. The operations of 1310 may be performed in accordance with examples as disclosed herein. In some examples, aspects of the operations of 1310 may be performed by an internet protocol layer messaging component 860 as described with reference to FIG. 8.

At 1315, the method may include receiving a MAC layer message including a response indicating a result generated by a first subset of processes of the coordinated multi-layer machine learning process, where the coordinated multi-layer machine learning process is provided as a service by the second UE, and where the response includes a header portion indicating at least one index corresponding to one or more service layers for the first subset of processes. The operations of 1315 may be performed in accordance with examples as disclosed herein. In some examples, aspects of the operations of 1315 may be performed by a response component 845 as described with reference to FIG. 8.

At 1320, the method may include outputting a second MAC layer message including a second result based on performing a second subset of processes of the coordinated multi-layer machine learning process on the received result. The operations of 1320 may be performed in accordance with examples as disclosed herein. In some examples, aspects of the operations of 1320 may be performed by a result component 850 as described with reference to FIG. 8.

The following provides an overview of aspects of the present disclosure:
Aspect 1: A method for wireless communications at a first UE, comprising: receiving a configuration signal that indicates a plurality of downlink slots and a plurality of configured grants for communicating on a plurality of uplink slots, wherein the plurality of downlink slots and the plurality of uplink slots are for communications from a plurality of UEs including the first UE, wherein the plurality of UEs perform a coordinated multi-layer machine learning process; transmitting an uplink signal in an uplink slot from the plurality of uplink slots in accordance with the configuration signal, wherein the uplink signal comprises an indication of a result from performing a first subset of processes of the coordinated multi-layer machine learning process; and receiving, after transmitting the uplink signal, a group physical downlink control channel signal indicating that an upcoming slot from the plurality of downlink slots or the plurality of uplink slots is allocated to a second UE from the plurality of UEs for performing a second subset of processes of the coordinated multi-layer machine learning process.
Aspect 2: The method of aspect 1, further comprising: receiving, prior to transmitting the uplink signal, a downlink signal in a downlink slot from the plurality of downlink slots in accordance with the configuration signal, the downlink signal comprising a prompt associated with the coordinated multi-layer machine learning process; and performing the first subset of processes of the coordinated multi-layer machine learning process using the prompt to identify the result.
Aspect 3: The method of any of aspects 1 through 2, further comprising: receiving, after transmitting the uplink signal, a downlink signal in a downlink slot from the plurality of downlink slots in accordance with the group physical downlink control channel, the downlink signal comprising a second result associated with the second subset of processes of the coordinated multi-layer machine learning process; and performing the first subset of processes of the coordinated multi-layer machine learning process using the second result to identify a third result.
Aspect 4: The method of aspect 3, further comprising: transmitting a second uplink signal in a second uplink slot from the plurality of uplink slots in accordance with the group physical downlink control channel, wherein the second uplink signal comprises an indication of the third result.
Aspect 5: The method of any of aspects 3 through 4, wherein the third result comprises a token in response to a prompt received from a user.
Aspect 6: The method of any of aspects 1 through 5, wherein the coordinated multi-layer machine learning process comprises a plurality of sub-layers associated with a large language model deployed as a service by the plurality of UEs.
Aspect 7: The method of any of aspects 1 through 6, wherein the first UE and the second UE in the plurality of UEs are associated with different modulation and coding schemes.
Aspect 8: The method of any of aspects 1 through 7, wherein the plurality of UEs are deployed using a centralized server or in a distributed operation.
Aspect 9: A method for wireless communications at a first UE, comprising: communicating an application layer message comprising a request for service indicating a request to participate in a coordinated multi-layer machine learning process; receiving a medium access control (MAC) layer message comprising a response indicating a result generated by a first subset of processes of the coordinated multi-layer machine learning process, wherein the coordinated multi-layer machine learning process is provided as a service by a second UE, and wherein the response comprises a header portion indicating at least one index corresponding to one or more service layers for the first subset of processes; and outputting a second MAC layer message comprising a second result based at least in part on performing a second subset of processes of the coordinated multi-layer machine learning process on the received result.
Aspect 10: The method of aspect 9, further comprising: communicating a second application layer message between the first UE and the second UE, the second application layer message comprising an indication of a set of service layers associated with the coordinated multi-layer machine learning process hosted at the second UE.
Aspect 11: The method of aspect 10, wherein communicating the application layer message further comprises: communicating the application layer message between the first UE and the second UE, the application layer message indicating at least one of the set of service layers associated with the coordinated multi-layer machine learning process based at least in part on the second application layer message.
Aspect 12: The method of any of aspects 9 through 11, further comprising: communicating an internet protocol layer message between the first UE and the second UE, the internet protocol layer message comprising an indication of a routing table associated with a service chain for the coordinated multi-layer machine learning process.
Aspect 13: The method of any of aspects 9 through 12, further comprising: receiving, from a third UE, a prompt for inputting into the coordinated multi-layer machine learning process, wherein the second result comprises a token in response to the received prompt.
Aspect 14: The method of any of aspects 9 through 13, wherein the coordinated multi-layer machine learning process comprises a plurality of sub-layers associated with a large language model.
Aspect 15: The method of any of aspects 9 through 14, wherein the first UE and the second UE are deployed using a centralized server or in a distributed operation.
Aspect 16: A first UE for wireless communications, comprising one or more memories storing processor-executable code, and one or more processors coupled with the one or more memories and individually or collectively operable to execute the code to cause the first UE to perform a method of any of aspects 1 through 8.
Aspect 17: A first UE for wireless communications, comprising at least one means for performing a method of any of aspects 1 through 8.
Aspect 18: A non-transitory computer-readable medium storing code for wireless communications, the code comprising instructions executable by one or more processors to perform a method of any of aspects 1 through 8.
Aspect 19: A first UE for wireless communications, comprising one or more memories storing processor-executable code, and one or more processors coupled with the one or more memories and individually or collectively operable to execute the code to cause the first UE to perform a method of any of aspects 9 through 15.
Aspect 20: A first UE for wireless communications, comprising at least one means for performing a method of any of aspects 9 through 15.
Aspect 21: A non-transitory computer-readable medium storing code for wireless communications, the code comprising instructions executable by one or more processors to perform a method of any of aspects 9 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
receive a configuration signal that indicates a plurality of downlink slots and a plurality of configured grants for communicating on a plurality of uplink slots, wherein the plurality of downlink slots and the plurality of uplink slots are for communications from a plurality of UEs including the first UE, wherein the plurality of UEs perform a coordinated multi-layer machine learning process;
transmit an uplink signal in an uplink slot from the plurality of uplink slots in accordance with the configuration signal, wherein the uplink signal comprises an indication of a result from performing a first subset of processes of the coordinated multi-layer machine learning process; and
receive, after transmitting the uplink signal, a group physical downlink control channel signal indicating that an upcoming slot from the plurality of downlink slots or the plurality of uplink slots is allocated to a second UE from the plurality of UEs for performing a second subset of processes of the coordinated multi-layer machine learning process.

2. The first UE of claim 1, wherein the one or more processors are individually or collectively further operable to execute the code to cause the first UE to:
receive, prior to transmitting the uplink signal, a downlink signal in a downlink slot from the plurality of downlink slots in accordance with the configuration signal, the downlink signal comprising a prompt associated with the coordinated multi-layer machine learning process; and
perform the first subset of processes of the coordinated multi-layer machine learning process using the prompt to identify the result.

3. The first UE of claim 1, wherein the one or more processors are individually or collectively further operable to execute the code to cause the first UE to:
receive, after transmitting the uplink signal, a downlink signal in a downlink slot from the plurality of downlink slots in accordance with the group physical downlink control channel, the downlink signal comprising a second result associated with the second subset of processes of the coordinated multi-layer machine learning process; and
perform the first subset of processes of the coordinated multi-layer machine learning process using the second result to identify a third result.

4. The first UE of claim 3, wherein the one or more processors are individually or collectively further operable to execute the code to cause the first UE to:
transmit a second uplink signal in a second uplink slot from the plurality of uplink slots in accordance with the group physical downlink control channel, wherein the second uplink signal comprises an indication of the third result.

5. The first UE of claim 3, wherein the third result comprises a token in response to a prompt received from a user.

6. The first UE of claim 1, wherein the coordinated multi-layer machine learning process comprises a plurality of sub-layers associated with a large language model deployed as a service by the plurality of UEs.

7. The first UE of claim 1, wherein:
the first UE and the second UE in the plurality of UEs are associated with different modulation and coding schemes.

8. The first UE of claim 1, wherein the plurality of UEs are deployed using a centralized server or in a distributed operation.

9. A first user equipment (UE), comprising:
one or more memories storing processor-executable code; and
one or more processors coupled with the one or more memories and individually or collectively operable to execute the code to cause the first UE to:
communicate an application layer message comprising a request for service indicating a request to participate in a coordinated multi-layer machine learning process;
receive a medium access control (MAC) layer message comprising a response indicating a result generated by a first subset of processes of the coordinated multi-layer machine learning process, wherein the coordinated multi-layer machine learning process is provided as a service by a second UE, and wherein the response comprises a header portion indicating at least one index corresponding to one or more service layers for the first subset of processes; and
output a second MAC layer message comprising a second result based at least in part on performing a second subset of processes of the coordinated multi-layer machine learning process on the received result.

10. The first UE of claim 9, wherein the one or more processors are individually or collectively further operable to execute the code to cause the first UE to:
communicate a second application layer message between the first UE and the second UE, the second application layer message comprising an indication of a set of service layers associated with the coordinated multi-layer machine learning process hosted at the second UE.

11. The first UE of claim 10, wherein, to communicate the application layer message, the one or more processors are individually or collectively further operable to execute the code to cause the first UE to:
communicate the application layer message between the first UE and the second UE, the application layer message indicating at least one of the set of service layers associated with the coordinated multi-layer machine learning process based at least in part on the second application layer message.

12. The first UE of claim 9, wherein the one or more processors are individually or collectively further operable to execute the code to cause the first UE to:
communicate an internet protocol layer message between the first UE and the second UE, the internet protocol layer message comprising an indication of a routing table associated with a service chain for the coordinated multi-layer machine learning process.

13. The first UE of claim 9, wherein the one or more processors are individually or collectively further operable to execute the code to cause the first UE to:
receive, from a third UE, a prompt for inputting into the coordinated multi-layer machine learning process, wherein the second result comprises a token in response to the received prompt.

14. The first UE of claim 9, wherein the coordinated multi-layer machine learning process comprises a plurality of sub-layers associated with a large language model.

15. The first UE of claim 9, wherein the first UE and the second UE are deployed using a centralized server or in a distributed operation.

16. A first user equipment (UE), comprising:
a processing system that includes processor circuitry and memory circuitry that stores code, the processing system configured to cause the first UE to:
communicate an application layer message comprising a request for service indicating a request to participate in a coordinated multi-layer machine learning process;
receive a medium access control (MAC) layer message comprising a response indicating a result generated by a first subset of processes of the coordinated multi-layer machine learning process, wherein the coordinated multi-layer machine learning process is provided as a service by a second UE, and wherein the response comprises a header portion indicating at least one index corresponding to one or more service layers for the first subset of processes; and
output a second MAC layer message comprising a second result based at least in part on performing a second subset of processes of the coordinated multi-layer machine learning process on the received result.

17. The first UE of claim 16, wherein the processing system is further configured to cause the first UE to:
communicate a second application layer message between the first UE and the second UE, the second application layer message comprising an indication of a set of service layers associated with the coordinated multi-layer machine learning process hosted at the second UE.

18. The first UE of claim 17, wherein, to communicate the application layer message, the processing system is further configured to cause the first UE to:
communicate the application layer message between the first UE and the second UE, the application layer message indicating at least one of the set of service layers associated with the coordinated multi-layer machine learning process based at least in part on the second application layer message.

19. The first UE of claim 16, wherein the processing system is further configured to cause the first UE to:
communicate an internet protocol layer message between the first UE and the second UE, the internet protocol layer message comprising an indication of a routing table associated with a service chain for the coordinated multi-layer machine learning process.

20. The first UE of claim 16, wherein the processing system is further configured to cause the first UE to:
receive, from a third UE, a prompt for inputting into the coordinated multi-layer machine learning process, wherein the second result comprises a token in response to the received prompt.
